(19) United States
(12) Patent Application Publication
(10) Pub. No.: US 2005/0044054 A1
(43) Pub. Date: Feb. 24, 2005

(54) Combinational circuit for detector and communication system

(76) Inventor: Joseph Dale Helmick, Columbus, OH (US)

Correspondence Address: Joe Helmick, #109, 5253 E. Broad St, Columbus, OH, 43213, US

(21) Appl. No.: 10/941,685

(22) Filed: Sep. 15, 2004

Related U.S. Application Data
(63) Continuation-in-part of application No. 09/878,811, filed on Jun. 10, 2001, now abandoned.
(60) Provisional application No. 60/216,455, filed on Jul. 6, 2000.
(60) Provisional application No. 60/256,445, filed on Dec. 19, 2000.

(51) Int. Cl. G06F 15/18; G06N 3/08

(52) U.S. Cl. 706/25

(57) ABSTRACT

Three algorithms enumerate the decimal expansions of e, π, (2)^{1/2} and (3)^{1/2} by using 1.) 16 special angles in radians on the unit circle in a transition from arbitrary-degrees to natural-radians defined as Δ (match-with-rotate algorithm), 2.) subsets of 7-1 special angles from 5π/6 to 5π/3 derived from the Pythagorean theorem such that −(−a)=−a, the square of imaginary i, i.e. i² does not equal −1, −does not equal −1, (−1)^{1/2}=i, (−)^{1/2}=yod (cusp root method algorithm), the 10^{th} letter of the Hebrew alphabet, akin to iota of Semitic origin, and 3.) 16 special angles in radians on zero vector algorithm defined in terms of the yod null set of only θ on the unit origin in polar coordinates, for the seed matrices as the mechanisms of sequence detection in a combinational circuit for target recognition of intelligent systems, a direction finding device and communication system.

This application claims priority under 35 USC 120 for a Continuation in Part application from prior petition application Ser. No. 09/878,811 with filing date of Jun. 10, 2001. Applicant hereby claims priority of provisional application Nos. 60/216,455 of filing date Jul. 6, 2000 and 60/256,445 of filing date Dec. 19, 2000.

### OTHER REFERENCES

R. D. Sriram, Intelligent Systems for Engineers, Springer-Verlag, Berlin, 1997, pp.341, 471-513.
M. Dresden, A Geometric Approach to Phase Transitions and Universality in IUPAP International Conference on Statistical Physics, ed. N. Menyhard, Academiai Kiado, Budapest, 1975, p.75.
W. H. Roadstrum & D. H. Wolayer, Electrical Engineering 2^{nd} ed., John Wiley & Sons Inc., New York, 1994, pp.354-405.
Yu Hen Yo, Programmable Digital Signal Processor, Marcel Dekker Inc. New York, 2002.
Hank Hogan ed., Astronomical Research in Photonics Spectra, Laurin, 38 7, Jul. 2004.
M. Mano & C. Kime, Logic and Computer Design Fundamentals, Pearson, 2004.

### BACKGROUND OF THE INVENTION

Field of the Invention

The invention presents a combinational circuit and detector with Digital Signal Processing (DSP) code in computer readable medium for the purpose of cluster, pattern and object recognition in detecting and communicating with intelligent systems. Also a function counter is presented for the computerized measurement of space properties.

### SUMMARY OF THE INVENTION

Analysis of the two most widely used transcendental numbers e and π extends from classical mechanics to mathematical applications like computing billions of digits of π. The computation of digits to extraordinary lengths demonstrates the value of mathematics to electrical and computer engineering. Introspection on the quantum aspect of the decimal expansions of e, π, (2)^{1/2} and (3)^{1/2} is more intuitively understood from the statistical mechanics of decimal positions relative to special angles in degrees and radians on the unit circle.

Application of the non-standard theory −(−a)=−a extends from arbitrary degrees to a measure of the natural scale of Euclidean geometry with a secondary extension to a complex group of symmetric and descending objects with one embedded quaternionic orbit. At the end of the −(−a)=−a yod group descent, 5π/4 on the unit circle makes sense in terms of −x=−y for a logical approach to a definition of zero vector, yod null set, in polar coordinates. Numeric simulations of the algorithms at 1,000,000 LengthOfString digits display preliminary evidence of convergence by the recurrence of 3 and 4-tuples in the data outputs.

The values (2)^{1/2} and (3)^{1/2} are specifically chosen because 2 and 3 are the only operands of the square root function in the solutions to sine, cosine and tangent computations from the standard double negative equals a positive view of the Pythagorean theorem and the special angles on the unit circle.

Novel software and a detector chip array are used to map the data output of a high level description of cluster recognition algorithms in computer readable medium to Field Programmable Gate Array (FPGA). The combinational circuit device comprises a detector and communication system of a cascading array in hybrid chips with digital integrated circuit and photodiodes. The function counter is of the form for the differential relation dL/dθ.

### BRIEF DESCRIPTION OF THE DRAWINGS

FIG. 1 shows a map of the closed loop for the numerical system;

FIG. 2 shows a flowchart of match-with-rotate algorithm (A operator) for arbitrary degrees-natural radians transition;

FIG. 3 shows a flowchart of cusp root method that derives (−)^{1/2}=yod;

FIG. 4 shows 16 special angle seed matrix;

FIG. 5 shows an edge representation of the seed matrices in special angles (solid lines);

FIG. 6 shows a simplified closed loop system in terms of seed matrix symmetry.

FIG. 7 shows a combinational logic circuit where the inputs are in a plurality of combinations of 2, 3, or 4. Seed matrices correspond to edges of the yod group in FIG. 5.

FIG. 8 shows a flowchart for a detector system.

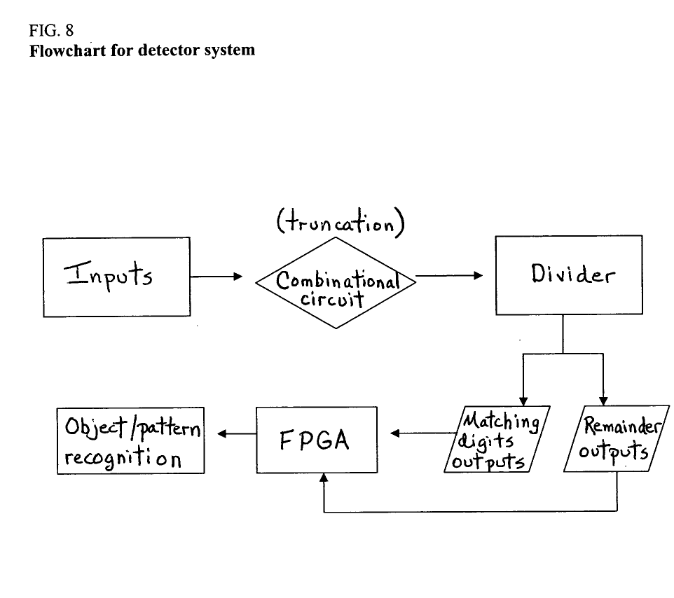

FIG. 9 shows yod cascaded array for the detector system.

FIG. 10 shows combinational circuit to analog conversion for communication system

### DETAILED DESCRIPTION OF THE INVENTION

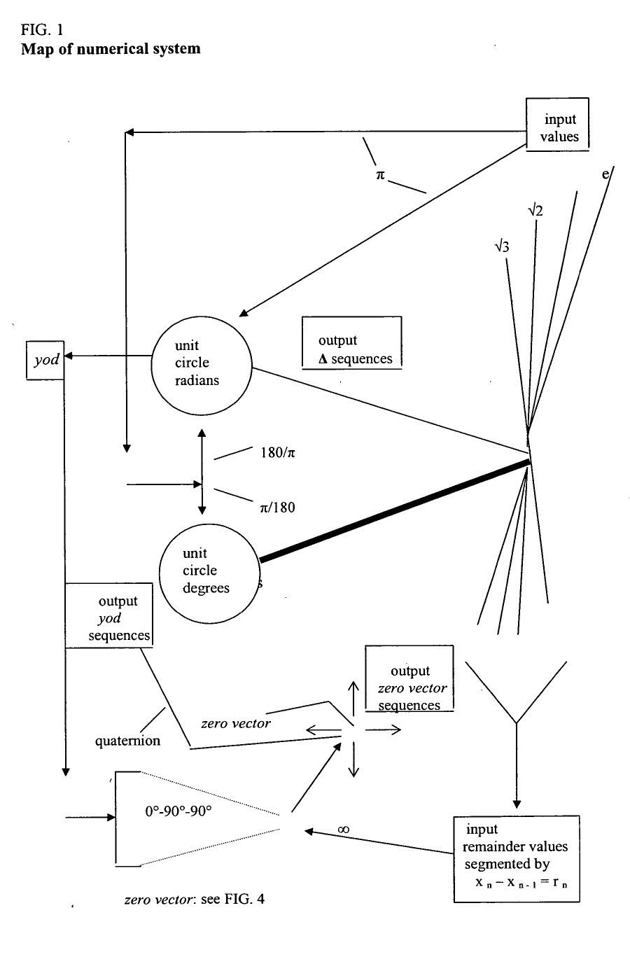

FIG. 1 shows phase space transitions of arbitrary degrees to natural radians, natural radians to yod, and yod to zero vector. The Δ represents match-with-rotate algorithm, yod represents cusp root method, and zero vector algorithm.

System architecture is devised from an intuitive relation of geometric angles between the decimal expansions of e and π, (2)^{1/2} and (3)^{1/2}, and the arbitrary degrees-natural radians conversion on the unit circle. A complex composition of functions, yod, orients the system to a symmetrical convergence of descending objects, which lead to a definition of zero vector.

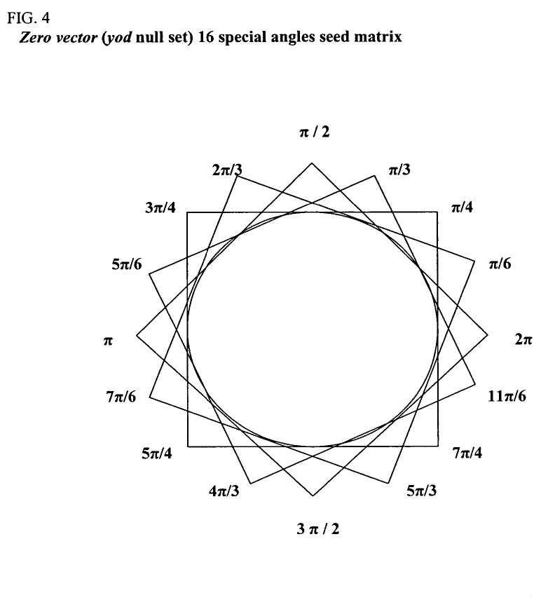

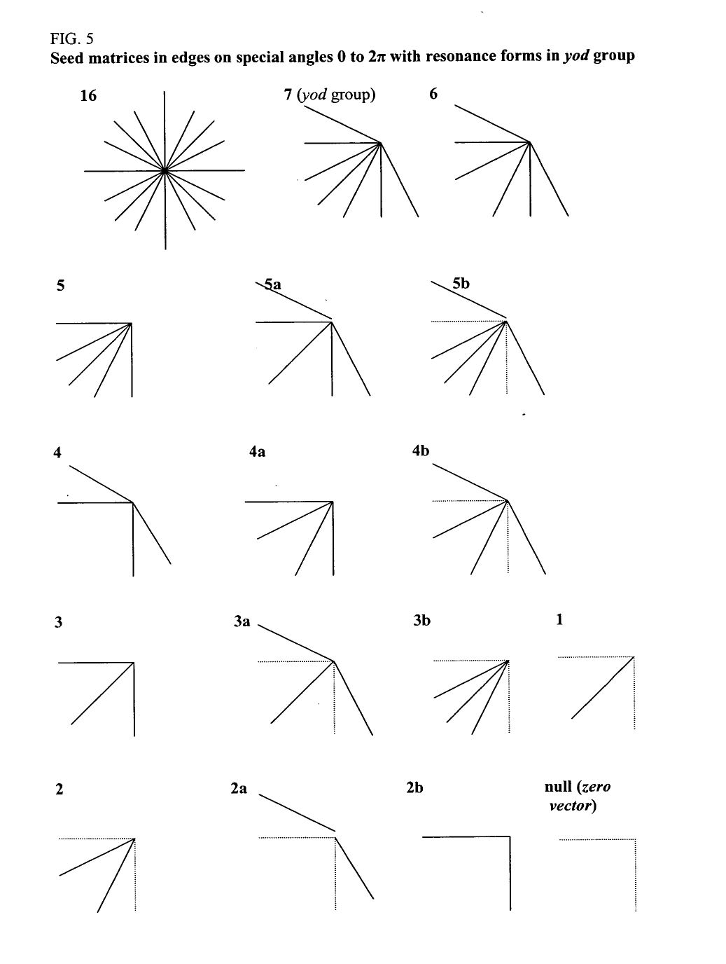

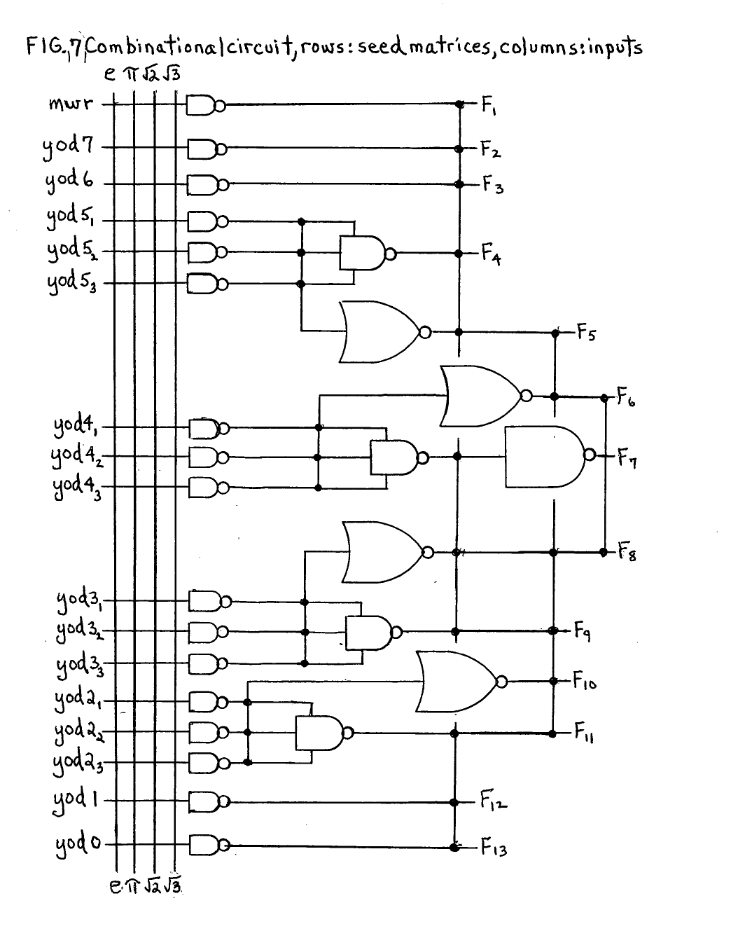

The seed matrices in edges for each operator are graphically represented in FIG. 5 with all 16 special angles (0πk to 2πk) for Δ, 7-1 combinations of special angles for 5π/6, π, 7π/6, 5π/4, 4π/3, 3π/2, 5π/3 with 3 resonance isomers in orbits 5, 4, 3, and 2 (FIG. 5), an infinite loop in FIG. 5 (4) and 16 seed matrices in zero vector (FIG. 4) demonstrate symmetrical systems of 16 by 7 by 16, branching to 16 by 3 by 1 by 3 by 16 (FIG. 7).

As a set of edges, special angles or vectors, the null set is part of the yod group by the Power Set Axiom. For this reason the null set of the yod group makes sense when defined as zero vector in terms of only θ on the unit origin in polar coordinates.

The output from Δ, yod, and zero vector sequences consist of sequences of matching digits, and matching special angles in degrees or radians that can be represented as infinite sums in telescopic series, matching special angle positions, and matching special angle positions in terms of sector-area. The variable ε=matching digits, μ=matching special angles, and v=index of position for matching digits and matching special angles in degrees.

$${\sum }_{v = 1}^{∞} {ξ}_{v} - {ξ}_{v - 1} = {Ψ}_{ξ}$$

The series of matching digits is convergent when the matching digits are always the same digit and repeats the same digit after reaching the limit, otherwise the series diverges.

$${\sum }_{v = 1}^{∞} {μ}_{v} - {μ}_{v - 1} = {ϕ}_{μ}$$

The series of matching special angles is convergent if there are no more matches in position according to special angles, otherwise if there are infinite many matches, the series diverges.

Matching special angle positions (1-16 mod 360) in terms of sector-area are represented by 1.) if (μᵥ mod 360)≧180°

$${\sum }_{v = 1}^{∞} \frac{( 360 - {μ}_{v} μ o δ 360 )}{360} ( π ) = {τ}_{μ}$$

and by 2.) μᵥmod 360<180

$${\sum }_{v = 1}^{∞} \frac{{μ}_{v} μ o δ 360}{360} ( π ) = {τ}_{μ}$$

The series of matching positions in terms of sector-area is convergent if μᵥ mod 360 is always zero after a certain point, otherwise the series diverges. In the convergent case, binary application of the matching special angle positions in sector-area mod 360 is valuable in digital detection and communication systems.

The output sequences for all combinations of seed matrices are 1.) matching digits 2.) matching special angles in degrees or radians 3.) matching special angle positions 4.) matching special angle positions in terms of sector-area and 5.) two, three, or four input remainder values segmented by xₙ−xₙ₋₁=rₙ. The sequences recombine at the origin of polar coordinates.

Digits are distributed in clusters (according to frequency of digits occurring in the x-component) over the sector-area. The coordinate pair y-component (matching special angles) is the height on the unit circle and is one-to-one correspondence with the matching special angle positions (in terms of sector area) data projection of clusters.

Zero vector is determined by 0 only and corresponds to the null set (FIG. 5) of the yod group, for example in the 16 special angles from 0+0πk+0 to 0+2πk+0 on the polar origin. Implementation of a non-Euclidean metric 0°−90°−90° triangle (FIG. 1) is an example of a random system designed for an infinite task. Definition of zero vector and elementary properties of vectors in a probability context suggest the curvature of a line between 2 points on a non-Euclidean surface results in the behavior of “shortest” lines such that 1.) a ±0 domain with +0 intersect −0=vacuous, 2.) vacuous does not equal True or False, 3.) null intersect null=disjoint, and 4.) a equals zero, a such that a²≠0.

The 0°−90°−90° metric, which extends to infinity at the vertex, is the shortest line. In the 0°−90°−90° metric, however, the ratio of orthogonal base angles to the vertex angle at infinity present polar coordinates at the origin that depend only on θ for a direction finding device of “shortest” line radii. The device uses a least squares map of minimally sufficient statistics in terms of system functions for Least Significant Bits (LSB) that will simplify the complex composition and origin of sinusoidal waveforms

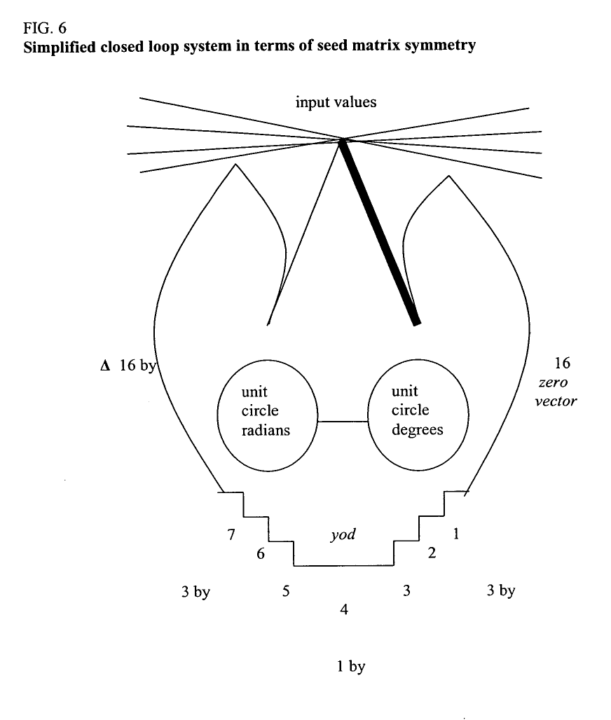

The balanced ratios of the uncertain system are: (16/16; 7/16 6/16 5/16 4/16 3/16 2/16 1/16; 16/16) that corresponds to 16 by 7 by 16 symmetry and (16/16; 7/16 6/16 5/16; 4/16 (infinite loop); 3/16 2/16 1/16; 16/16) that corresponds to 16 by 3 by 1 by 3 by 16 symmetry (FIG. 6) and the case 16 by 8 for null set=zero vector as an element of yod.

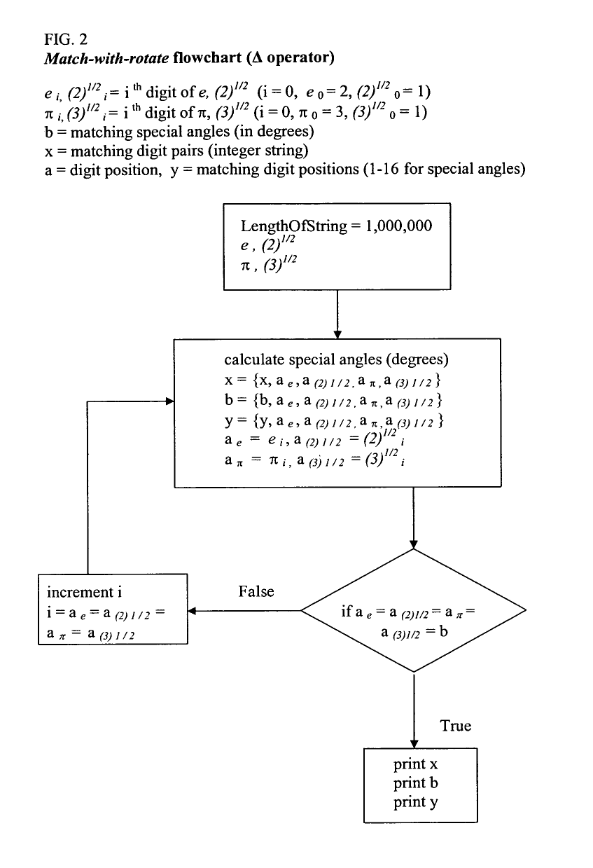

Match-with-rotate flowchart (FIG. 2) has an internal representation of input values e, π, (2)^{1/2} and (3)^{1/2} in a base 10, base 2, base 8 or base 16 system including base 10 for interpretation. Special angles are represented by, for example, π/2 as 0+2πk+30+60 or 3π/2 as 0+2πk+30+60+180 for all 16 special angles.

The code of the algorithm is as follows:

Programming Parameters & Packages

Needs [“ Graphics′ Graphics′ ” ]
Needs [“ Statistics′ DataManipulation′ ” ]
LengthofString = 1000000

Digit Representations
d = RealDigits [ E, 10, LengthofString ] [[1]];
c = RealDigits [ Pi, 10, LengthofString ] [[1]];
Digit Representations in Special Angles

SpecialAngles =

(Table [

{0 + 2 Pi k + 30, 0 + 2 Pi k + 30 + 15, 0 +
2 Pi k + 30 + 30, 0 + 2 Pi k +30 + 60, 0 + 2 Pi k + 30 +
90, 0 + 2 Pi k + 30 + 15 + 90, 0 + 2 Pi k + 30 + 30 + 90,
0 + 2 Pi k + 30 + 60 + 90, 0 + 2 Pi k + 30 + 180, 0 +
2 Pi k + 30 + 15 + 180, 0 + 2 Pi k + 30 + 30 + 180, 0 +
2 Pi k + 30 + 60 + 180, 0 + 2 Pi k + 30 + 270, 0 +
2 Pi k + 30 + 15 + 270, 0 + 2 Pi k + 30 + 30 + 270, 0 +
2 Pi k + 30 +60 + 270}, {k, 0, .95 LengthOfString /
360}]/ / Flatten) /. Pi → 180;

cc = Part [c, (Table [

{0 + 2 Pi k +30, 0 + 2 Pi k + 30 + 15, 0 + 2 Pi k + 30 +
30, 0 + 2 Pi k + 30 + 60, 0 + 2 Pi k + 30 + 90, 0 + 2 Pi k +
30 + 15 + 90, 0 + 2 Pi k + 30 + 30 + 90, 0 + 2 Pi k + 30 +
60 + 90, 0 + 2 Pi k + 30 + 180, 0 + 2 Pi k + 30 + 15 +
180, 0 + 2 Pi k + 30 + 30 + 180, 0 + 2 Pi k + 30 + 60 +
180, 0 + 2 Pi k + 30 + 270, 0 + 2 Pi k + 30 + 15 + 270,
0 + 2 Pi k + 30 + 30 + 270, 0 + 2 Pi k + 30 + 60 + 270},
{k, 0, .95 LengthOfString / 360}]/ / Flatten) /. Pi → 180

];

dd = Part [ d, (Table [

{0 + 2 Pi k + 30, 0 + 2 Pi k + 30 + 15, 0 + 2 Pi k +
30 + 30, 0 + 2 Pi k + 30 + 60, 0 + 2 Pi k + 30 + 90, 0 +
2 Pi k + 30 + 15 + 90, 0 + 2 Pi k + 30 + 30 + 90, 0 +
2 Pi k + 30 + 60 + 90, 0 + 2 Pi k + 30 + 180, 0 + 2 Pi k +
30 + 15 + 180, 0 + 2 Pi k + 30 + 30 + 180, 0 + 2 Pi k +
30 + 60 + 180, 0 + 2 Pi k + 30 + 270, 0 + 2 Pi k + 30 +
15 + 270, 0 + 2 Pi k + 30 + 30 + 270, 0 + 2 Pi k +30 +60 +
270}, {k, 0, .95 LengthOfString / 360}]/ / Flatten) /.
Pi → 180

];

Length [cc]

Special Angle Number ( 1 = Pi / 6, 2 = Pi/4 . . .) for Matching
Digit Positions

Flatten [ Position [ Table [dd [[k]], = = {k, 1, Length [cc]}],True]]

Matching Special Angles

Part [

(Table [

{0 + 2 Pi k + 30, 0 + 2 Pi k + 30 + 15, 0 + 2 Pi k + 30 +
30, 0 + 2 Pi k + 30 + 60, 0 + 2 Pi k + 30 + 90, 0 + 2 Pi k +
30 + 15 + 90, 0 + 2 Pi k + 30 + 30 + 90, 0 + 2 Pi k + 30 +
60 + 90, 0 + 2 Pi k + 30 + 180, 0 + 2 Pi k + 30 + 15 +
180, 0 +2 Pi k + 30 + 30 + 180, 0 + 2 Pi k + 30 + 60 +
180, 0 + 2 Pi k + 30 + 270, 0 + 2 Pi k + 30 + 15 + 270,
0 + 2 Pi k + 30 + 30 + 270, 0 + 2 Pi k + 30 + 60 + 270},
{k, 0, .95 LengthOfString / 360}]/ / Flatten) /.Pi → 180,

Flatten [%]
]

Matching Digit Pairs

MatchingDigits = c [[% ]]
d [[%%]]

Frequencies [MatchingDigits ]
Histogram [Matching Digits]
Table [ListPlot [Transpose [{Drop [MatchingDigits, k], Drop
[MatchingDigits, - k]}]],

{k, 1, 100, 10}]-

Match-with-rotate algorithm counts the digits in combinations of e, π, (2)^{1/2} and (3)^{1/2} starting with the first digit and not counting the place descriptor decimal point. Each of 16 special angles from 0πk to 2πk (where k is greater than or equal to 1) is counted in degrees of r=180. The sequence of special angles consists of those angles mod 360, which correspond to the 16 special angles between 0 and 2π. If the digits of e π, (2)^{1/2} and (3)^{1/2} decimal expansions match at the same position and the position has a one-to-one correspondence to the same number of degrees defined by a special angle on the unit circle, the algorithm generates an integer sequence of matching digit pairs, a radian sequence of matching special angles, a special angle position sequence, and the special angle position sequence in terms of sector-area.

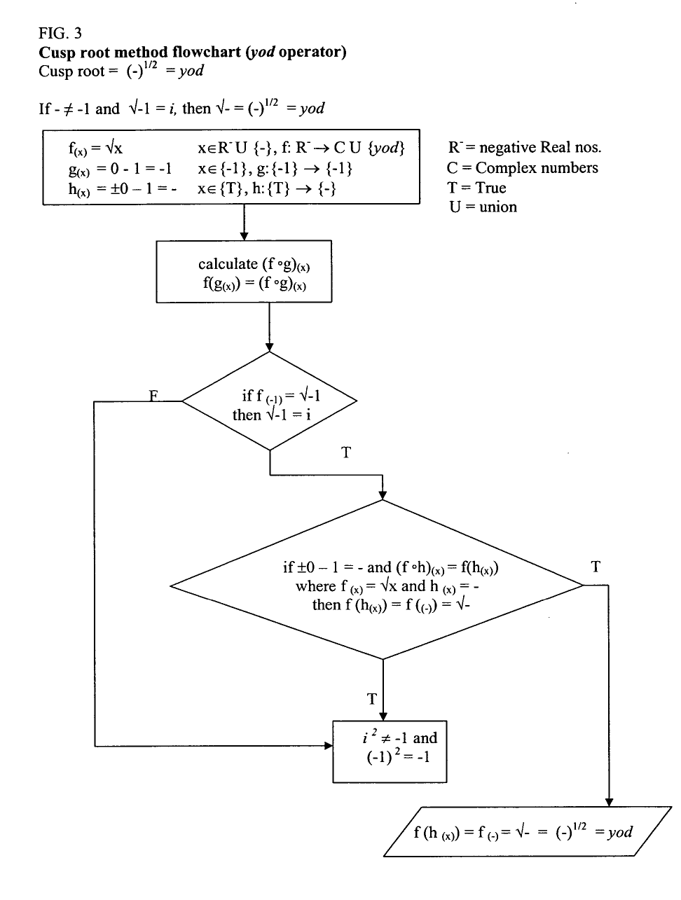

Similar in function to match-with-rotate algorithm, yod (FIG. 3) is defined as one factored from the square root of negative one. The fundamental definition of yod as a complex number, is the square root of a negative sign, (−)^{1/2}. Derived from the Pythagorean theorem and −(−a)=−a, the result is a 7-element seed matrix symmetric about and including 5π/4 (5π/6, π, 7π/6, 5π/4, 4π/3, 3π/2, 5π/3). Table 1 shows the Pythagorean equations using −(−a)=−a for (−)^{1/2}=yod computations in 8-14. Secondary results are numbers 7 and 15 where c=0, numbers 1-5 where c=1, and numbers 6 and 16 where c=√2/2.

TABLE 1
Pythagorean equations to determine (−)^{1/2} = yod from 16 special angles
on the unit circle from zero to 2π with −(−a) = −a

$\begin{matrix} 1. & {( cosine 0 )}^{2} + {( sine 0 )}^{2} = {c}^{2} \\ & {1}^{2} + {0}^{2} = {c}^{2} \\ & c = 1\end{matrix}$
$\begin{matrix} 2. & {( cos π / 6 )}^{2} + {( sin π / 6 )}^{2} = {c}^{2} \\ & {( \sqrt{3 / 2} )}^{2} + {( 1 / 2 )}^{2} = {c}^{2} \\ & 3 / 4 + 1 / 4 = {c}^{2} \\ & c = 1\end{matrix}$
$\begin{matrix} 3. & {( cos π / 4 )}^{2} + {( sin π / 4 )}^{2} = {c}^{2} \\ & {( \sqrt{2 / 2} )}^{2} + {( \sqrt{2 / 2} )}^{2} = {c}^{2} \\ & 1 / 2 + 1 / 2 = {c}^{2} \\ & c = 1\end{matrix}$
$\begin{matrix} 4. & {( cos π / 3 )}^{2} + {( sin π / 3 )}^{2} = {c}^{2} \\ & {( 1 / 2 )}^{2} + {( \sqrt{3 / 2} )}^{2} = {c}^{2} \\ & c = 1\end{matrix}$
$\begin{matrix} 5. & {( cos π / 2 )}^{2} + {( sin π / 2 )}^{2} = {c}^{2} \\ & {0}^{2} + {1}^{2} = {c}^{2} \\ & c = 1\end{matrix}$
$\begin{matrix} 6. & {( cos 2 π / 3 )}^{2} + {( sin 2 π / 3 )}^{2} = {c}^{2} \\ & {( - 1 / 2 )}^{2} + {( \sqrt{3 / 2} )}^{2} = {c}^{2} \\ & - 1 / 4 + 3 / 4 = {c}^{2} \\ & 1 / 2 = {c}^{2} \\ & c = \sqrt{2 / 2}\end{matrix}$
$\begin{matrix} 7. & {( cos 3 π / 4 )}^{2} + {( sin 3 π / 4 )}^{2} = {c}^{2} \\ & {( - \sqrt{2 / 2} )}^{2} + {( \sqrt{2 / 2} )}^{2} = {c}^{2} \\ & - 1 / 2 + 1 / 2 = {c}^{2} \\ & c = 1\end{matrix}$
$\begin{matrix} 8. & {( cos 5 π / 6 )}^{2} + {( sin 5 π / 6 )}^{2} = {c}^{2} \\ & {( - \sqrt{3 / 2} )}^{2} + {( 1 / 2 )}^{2} = {c}^{2} \\ & - 3 / 4 + 1 / 4 = {c}^{2} \\ & {c}^{2} = - 1 / 2 \\ & c = ( \sqrt{- 1 / 2} ) = ( ( \sqrt{-} ) \sqrt{2 / 2} ) = {( - )}^{1 / 2} \sqrt{2 / 2}\end{matrix}$
$\begin{matrix} 9. & {( cos π )}^{2} + {( sin π )}^{2} = {c}^{2} \\ & - {1}^{2} + {0}^{2} = {c}^{2} \\ & c = \sqrt{- 1} = \sqrt{-} = {( - )}^{1 / 2}\end{matrix}$
$\begin{matrix}10. & {( cos 7 π / 6 )}^{2} + {( sin 7 π / 6 )}^{2} = {c}^{2} \\ & {( - \sqrt{3 / 2} )}^{2} + {( - 1 / 2 )}^{2} = {c}^{2} \\ & - 3 / 4 + - 1 / 4 = {c}^{2} \\ & - 1 = {c}^{2} \\ & c = \sqrt{- 1} = \sqrt{-} = {( - )}^{1 / 2}\end{matrix}$
$\begin{matrix}11. & {( cos 5 π / 4 )}^{2} + {( sin 5 π / 4 )}^{2} = {c}^{2} \\ & {( - \sqrt{2 / 2} )}^{2} + {( - \sqrt{2 / 2} )}^{2} = {c}^{2} \\ & - 1 / 2 + - 1 / 2 = {c}^{2} \\ & - 1 = {c}^{2} \\ & c = \sqrt{- 1} = \sqrt{-} = {( - )}^{1 / 2}\end{matrix}$
$\begin{matrix}12. & {( cos 4 π / 3 )}^{2} + {( sin 4 π / 3 )}^{2} = {c}^{2} \\ & {( - 1 / 2 )}^{2} + {( - \sqrt{3 / 2} )}^{2} = {c}^{2} \\ & - 1 / 4 + - 3 / 4 = {c}^{2} \\ & {c}^{2} = - 1 \\ & c = \sqrt{-} = {( - )}^{1 / 2}\end{matrix}$
$\begin{matrix}13. & {( cos 3 π / 2 )}^{2} + {( sin 3 π / 2 )}^{2} = {c}^{2} \\ & {0}^{2} + {( - 1 )}^{2} = {c}^{2} \\ & {c}^{2} = - 1 \\ & c = \sqrt{-} = {( - )}^{1 / 2}\end{matrix}$
$\begin{matrix}14. & {( cos 5 π / 3 )}^{2} + {( sin 5 π / 3 )}^{2} = {c}^{2} \\ & {( 1 / 2 )}^{2} + {( - \sqrt{3 / 2} )}^{2} = {c}^{2} \\ & 1 / 4 + - 3 / 4 = {c}^{2} \\ & {c}^{2} = - 1 / 2 \\ & c = ( \sqrt{- 1 / 2} ) = ( ( \sqrt{-} ) \sqrt{2 / 2} ) = {( - )}^{1 / 2} \sqrt{2 / 2}\end{matrix}$
$\begin{matrix}15. & {( cos 7 π / 4 )}^{2} + {( sin 7 π / 4 )}^{2} = {c}^{2} \\ & {( \sqrt{2 / 2} )}^{2} + {( - \sqrt{2 / 2} )}^{2} = {c}^{2} \\ & 1 / 2 + - 1 / 2 = {c}^{2} \\ & c = 0\end{matrix}$
$\begin{matrix}16. & {( cos 11 π / 6 )}^{2} + {( sin 11 π / 6 )}^{2} = {c}^{2} \\ & {( \sqrt{3 / 2} )}^{2} + {( - 1 / 2 )}^{2} = {c}^{2} \\ & 3 / 4 + - 1 / 4 = {c}^{2} \\ & 1 / 2 = {c}^{2} \\ & c = \sqrt{2 / 2}\end{matrix}$

Also similar in function to match-with-rotate algorithm, zero vector (FIG. 4) uses 16 special angles in radians on zero vector defined in terms of the yod null set of only θ on the unit origin of polar coordinates, for example, 0+(2π)k+0 or 0+(0π)k+0.

The operators Δ, yod, and zero vector are implemented by appending to the wave equation to detect and decipher intelligent systems from sky surveys of patterns in sinusoidal waveforms. The transmission of signals generated from output sequences is important for deep space communications systems with a signed range for the ratio of frequency to bias (S/N) using Least Significant Bit (LSB) per Volt. Sky surveys with an electromagnetic transmitter of oscillator and amplifier with receiver need to append Δ, yod, and zero vector complex numbers to the wave equation so that clusters, patterns and objects can be detected, received and transmitted.
∂²Ey/∂t²=A cos[ωt+Δφ°] A=amplitude, ω=radian frequency, and φ=phase in degrees
∂²Ey/∂t²=A cos[(−)^{1/2}ωt+φ°]
∂²Ey/t²=A cos(ωt+φ°)(zero vector)
∂²Ey/∂t²=A cos[(−)^{1/2}ωt+Δφ°]
∂²Ey/∂t²=A cos[(−)^{1/2}ωt+Δφ°](zero vector)
∂³Ey/∂t³=A cos[ωt+Δφ°] A=amplitude, ω=radian frequency, and φ=phase in degrees
∂³Ey/∂t³=A cos[(−)/^{1/2}ωt+φ°]
∂³Ey/∂t³=A cos(ωt+φ°)(zero vector)
∂³Ey/∂t³=A cos[(−)^{1/2}ωt+Δφ°]
∂³Ey/∂t³=A cos[(−)^{1/2}ωt+Δφ°](zero vector)

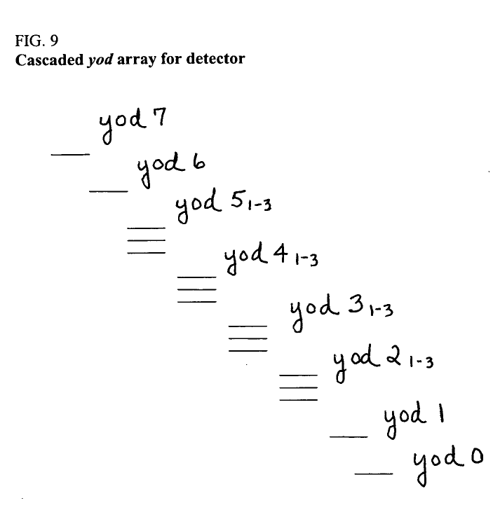

The novel difference with the prior art is that the chips are sequenced together in a cascaded array (FIG. 9). They are optimized for different wavelengths and resolutions by using filters. The detection area runs to the edge of the chip for most of the edges for close packing and minimize gap sizes. To accomplish this bonding pads along the chip edge are eliminated. To build the detector, the integrated circuit chip is bonded by a conducting indium bump to a photodiode array, one photodiode and bump per pixel. The detector has low dark current and is operable to 40 K temperature. The chips are used in a cascaded array similar to a step design. (FIG. 9)

For example, if in the Taylor series for sin t about t=0, Euler's formula uses iota and electrical engineering j in z=r(cos θ+j sin θ) to electric charge q and e^{qθ}=cos θ+q sin θ, then yod as in a cascaded array of multiple fields measured by a voltage follower such that e^{yod θ}=cos θ+yod sin θ=z identifies occupied orbitals for high energy delta or phi bonds from measured fields of data. Further, if mathematical yod implies a new sequential series to an equivalent charge descriptor from measured experiments, then a corresponding sub-electron particle of specific charge density is also identified.

The cascaded design is displayed in the yod figure (FIG. 9) and consists of 7 steps plus resonance forms. The differential relation dL/dθ, where L is LengthofString for input values according to decimal position and θ is the special angles on the unit circle in conversion from degrees to radians, identifies the special angles on the unit circle mod 360 in degrees as the counting mechanism for detection of clusters, patterns or objects in the computerized measurement of space properties.

The operational function, dL/dθ where L is LengthofString for π, e, (2)^{1/2} or (3)^{1/2} decimal expansions and θ is the 16 special angles converted from degrees to radians, is expressed as a quotient of integers where the numerator is in terms of length of decimal position and the denominator in terms of degrees/radians on the unit circle mod 360.

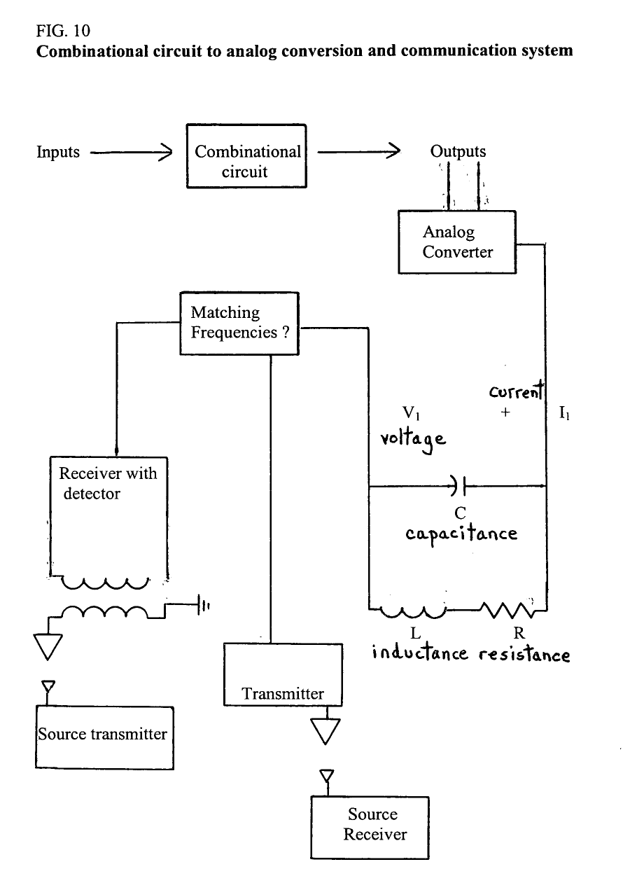

A digital to analogue converter takes the sets of logic lines from FIG. 7 as input and produces output signal on a single pair of wires (FIG. 10) for a communication system.

By using FPGA, cluster, pattern and object recognition is quickly adapted to new algorithms. The system, when detected, is compared with the known or unknown system to verify identity. The software tool can also convert the algorithm of a previously clustered system into a format that can be loaded into another system for compatibility.

The digital design is a combinational circuit and comprises programmable array logic (PAL) with OR array and programmable AND gates. The difference in the PAL device is that product terms can not be shared across 2 or more OR gates. FIG. 7 shows the logic configuration with four inputs arranged in columns, seventeen seed matrices plus resonance forms and multiple combinations of output fields. A programmable logic array (PLA) is also understood to replace the decoder by a set of AND gates programmed by match-with-rotate, yod and zero vector and selectively connect to OR gates. Field Programmable Gate Arrays (FPGA) are not fixed and reprogrammable after implementation. The PLDs are used to 1.) make or break interconnections 2.) build look-up tables and 3.) control transistor switching.

The outputs F₁-F₁₃ plus resonance forms and a plurality of combinations are used for cluster, pattern and object recognition of intelligent systems in sinusoidal waveforms, spinning black holes and autonomic neural systems. The establishment a deep space communication system including transmitter and receiver will use the direction finding device based on least squares equations of data outputs.

1. A programmable combinational circuit.

2. The claim of 1 in which a Digital Signal Processing detector consists of cluster recognition software as an article of manufacture in computer readable medium.

3. The claim of 1 for a function counter based on the differential relation dL/dθ for the computerized measurement of radian, yod and zero vector spaces.

4. The claim of 1 for a combinational circuit with digital to analog converter and analog circuit.

5. The claim of 1 for a direction finding device.

6. The claim of 1 for a communication system.
